(19) United States
(12) Patent Application Publication
(10) Pub. No.: US 2007/0150313 A1
(43) Pub. Date: Jun. 28, 2007

(54) Method for evaluating the quality of electronically stored, particularly medical, knowledge data

(76) Inventors: Klaus Abraham-Fuchs, Erlangen (DE); Eva Rumpel, Erlangen (DE); Markus Schmidt, Nurnberg (DE); Siegfried Schneider, Erlangen (DE); Horst Schreiner, Furth (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/589,536

(22) PCT Filed: Feb. 1, 2005
(86) PCT No.: PCT/EP05/50410

§ 371 Date: Aug. 16, 2006

(30) Foreign Application Priority Data
Feb. 18, 2004 (DE) 10 2004 008 191.3
Oct. 28, 2004 (DE) 10 2004 052 469.6

(51) Int. Cl. G06Q 50/00

(52) U.S. Cl. 705/3

(57) ABSTRACT

A method is for evaluating the quality of electronically stored, particularly medical, knowledge data. The knowledge data are stored in a database; quality data correlated with the knowledge data are stored in the database, and; when a user accesses the knowledge data, the quality data are automatically provided to the user.

### PRIORITY STATEMENT

This application is the national phase under 35 U.S.C. § 371 of PCT International Application No. PCT/EP2005/050410 which has an International filing date of Feb. 1, 2005, which designated the United States of America and which claims priority on German Patent Applications number DE 10 2004 008 191.3 filed Feb. 18, 2004, and number DE 10 2004 052 469.6 filed Oct. 28, 2004, the entire contents of each of which are hereby incorporated herein by reference.

### FIELD

The invention generally relates to a method for the quality evaluation of electronically stored, in particular medical knowledge data.

### BACKGROUND

Knowledge and information are often stored in electronic form as knowledge data. Examples of this are lexical knowledge in knowledge databases, phonebook or address entries in CD-ROMs or webpage content with weather forecasts which can be consulted via the Internet or suitable browsers. The quality i.e. reliability, source, soundness etc. of the knowledge are of crucial importance for a user consulting the stored knowledge; with three mutually differing weather forecasts, for example, a user of a plurality of different Internet weather services would wish to know which is the most reliable.

In the case of the knowledge taken from knowledge databases or CD-ROMs, the source is usually indicated or can be found so that the knowledge quality can be checked or unequivocally tracked, for example in a phonebook database from “Deutsche Telekom” or a lexical CD-ROM from a renowned publishing house such as “Brockhaus”. The quality evaluation of knowledge available on the Internet, however, often presents problems. The source, supplier i.e. service provider, author, creation date etc. are often not indicated or do not allow any conclusions to be made about the data quality of the content, since they are unknown to the user. Thus, objective and quantitative or even only qualitative evaluation of the quality of the knowledge usually can be carried out not at all or only with difficulty.

Particularly in respect of medical knowledge or information relating to healthcare, lacking or inaccessible quality assessment is a problem since the user of the knowledge does not have the opportunity to check the accuracy or reliability of such knowledge. For instance, a user of medical knowledge services on the Internet does not know whom they should trust when, for example, two conflicting therapy proposals are available for a given health problem or very different dosages are indicated for medications. Above all, the problem is that application of the available knowledge can have critical consequences.

Quality evaluation of knowledge nowadays either is carried out subjectively and spontaneously by the user of the knowledge, or is based on empirical values. For example, it is known from verbal communication within a group of individuals that the health tips of an Internet database “A” often given fast relief or improvement of complaints, while the recommendations of “B” are rarely successful.

For example, the indicated number of content hits of an Internet site or a subjective evaluation in free text form by an unknown user gives no indication about the quality of the knowledge since for the user, for example, it is still not clear which persons or institutions carried out the evaluation when, whether it is fully comprehensive and trustworthy, objective, or according to which standards the evaluation was made. The procedure of such a quasi-quality evaluation is not documented. There is no generally acknowledged certificate for quality evaluation (seal of quality).

### SUMMARY

At least one embodiment of the present invention improves the quality evaluation of electronically stored, in particular medical knowledge data.

At least one embodiment of a method is for the quality evaluation of electronically stored, in particular medical knowledge data. The method, in least one embodiment, includes the following. The knowledge data are stored in a database. Quality data correlated with the knowledge data are stored in the database. When a user accesses the knowledge data, the quality data are automatically provided to the user.

Quality data correlated with knowledge data can be divided as follows into quality assurance and quality evaluation data.

Examples of source-related quality assurance and/or quality evaluation data are: Identification of the originator of the knowledge, creation date of the knowledge or acknowledged (quality) certificates assigned to the knowledge. Such quality data are usually stored together with the knowledge during creation of the knowledge data, and are predominantly objective in nature.

User-related quality evaluation data are assessments by the user about the knowledge quality or results or success (failure) achieved by the user with the aid of the knowledge data. Such data are not created until or after the knowledge data are used by the user, and are added to the database while consulting the knowledge data or after having finished using the knowledge data.

Quality evaluation data are therefore data which reflect the use, success or results generated by applying the knowledge data. They may be qualitative (“good”, “bad”) or else purely verbal in nature (free text), but also quantitative values (blood pressure, recovery time) which are referred to as a quality measure or quality index.

Since the quality data are correlated with the knowledge data and stored in the form of quality data, they are permanently assigned to the knowledge data as a quantitative or qualitative quality measure.

When storing the knowledge and quality data, it is not important whether they are stored together in one database or in different distributed databases, even networked over large distances.

Users are persons who read, store or forward the knowledge data, or an automatic system or program, e.g. automatic expert decision support or workflow management systems which access the knowledge data.

Access to the knowledge data is in this case reading or processing, or else a preliminary inquiry or request to read the knowledge data, which precedes the actual consulting of the data, or possibly even storage of the knowledge data or their exchange or communication.

The determined or stored quality data now no longer need to be transmitted over irregular communication paths, for example by word of mouth, rather access to them is ensured from everywhere where the knowledge data themselves can be accessed. By automatically making the quality data available, each user of the knowledge data is also informed automatically about the quality data.

A user of the knowledge data is for example informed automatically about the quality data by only ever displaying both data together on a screen.

By the method of at least one embodiment, it is possible to track the use, utility, evaluation, consultation and application of knowledge data from the time of electronic storage, i.e. for example the entry of knowledge in the form of knowledge data into an electronic knowledge database. It is possible to track the “path” of the knowledge which is stored in an information or knowledge system, i.e. its use, modification, extension.

The user may store quality data in the database during or after access to the knowledge data. Here, the responsibility to save quality data lies with the user. They may, for example, be left to decide when and to what extent they do this.

The evaluation is in this case carried out purely on the basis of the knowledge data, without yet having to obtain results of their application or use.

The user may assign a quality measure to the knowledge data with the aid of freely selectable quality criteria. A freely selectable quality criterion is, for example, asking the user “How helpful was the information for you?” The user formulates a clear text response to this, or indicates a number from 0% to 100%. Such quality evaluation can be carried out in a very straightforward way since, for example, the quality measure is determined spontaneously when consulting the knowledge data. In this way, for example, a qualitative description is assigned to the knowledge data as a quality measure.

Since the quality data are determined during access, i.e. use or a read request, the access is thereby documented, logged, evaluated or recorded. No unobserved or unregistered use therefore takes place.

The user may also apply the knowledge data first, quality data correlated with the results of the application only then being stored in the database.

Such allocation of quality data to the knowledge data entails a feedback of the use of the knowledge to itself. The quality data informing about the use are definitively associated with the knowledge data. The assessment or evaluation of the knowledge data is accessible and transparent for their future use.

Upon each application i.e. use of the knowledge data, the opportunity is provided to query the result of the use, request an interaction by the user etc. Information about the use is not lost.

Preselected quality criteria correlated with the knowledge data may be stored in the database.

All criteria which are suitable for classifying the corresponding knowledge data according to use, information content, reliability, topicality etc. may be envisaged as quality criteria. Quality criteria are predetermined sub-categories from the possible use or possible results of working with the knowledge data, for example diagnoses, prescriptions, therapeutic measures, measurable treatment success, treatment costs, consequential diseases and hospital bed times. Quality evaluation data and quality indices are preferably assigned predefined quality criteria. Quality criteria may be indices (tumor of size×cm), threshold values for indices (blood pressure greater than y), working results (for example diagnoses or findings) or expert rules (for example, if finding=“diabetes” and “blood pressure less than”, then success index calculated from formula A).

Quality criteria can thus be both criteria which measure the quality or use of the available knowledge data themselves, and criteria which measure the success of the application of the knowledge data by the user. Optionally, by way of the quality data, it is therefore possible to measure both the quality of the knowledge data and the quality of the users of the knowledge data.

An identification of the user may be assigned to the quality data and stored in the database. The user of the data is thereby uniquely identified and can be contacted in connection with the knowledge or quality data. Identification may, for example, be the user's name or a unique ID. Together with the identification of the user, for example, it is also possible to store the time of use and thus establish a chronological connection between users and knowledge data, which is accessible at any time or usable for further knowledge consultations.

If the user determines quality data with a time delay after application of the knowledge data, then the user may be automatically requested to store the quality data in the database at predetermined times.

This may, for example, be done by a query in the form of an e-mail to the user, which requests them to enter the missing quality evaluation data. Conditions may also be linked to the storage of the quality data, for example a bonus reward for delivered quality data, a warning or temporary exclusion from future access to knowledge data for nondisclosure of quality data.

If the use of the knowledge data leads to an action, for example a decision, a diagnosis or a therapy, then the use of the knowledge data can be checked against the result of the action.

Quality criteria in this case may, for example, be the success or failure of a medical intervention, the shortening of a recovery time, the normalization of a measurement value in the patient or the subjective observation and evaluation of the corresponding results.

If result data from the application of knowledge data are stored in a result database, then quality data correlated with the application of the knowledge data may be automatically generated and stored in the database.

If the application of the knowledge data leads to a mode of action, procedure or the like which delivers result data, for example in the form of a measurement value such as blood pressure, pulse, regression of a tumor, length of a recovery time, reduction of side-effects etc., then this result may be stored in a result database. This is, for example, an electronic patient file or a database of a family doctor.

The use of the knowledge data may lead to a result which can be evaluated with the aid of predetermined quality criteria. The quality measure is then determined automatically with the aid of the outcome.

Since the quality evaluation is carried out automatically, the user is no longer burdened with it and cannot forget the evaluation. The evaluation is objective, verifiable at any time and reproducible.

If the result database is an electronic patient database or an electronic hospital information system, then patient outcome data may be stored as result data in the result database.

Patient outcome data are, for example, diagnoses, prescriptions, therapeutic measures, measurable treatment success, treatment costs, consequential diseases and hospital bed times.

Quality data may be determined from the result database according to preselected quality criteria, and the quality data may be stored in the database.

Parameters measurable by acknowledged experts in the corresponding knowledge field, against which the quality of the knowledge application is subsequently measured, may be preselected or specified as quality criteria for the quality evaluation, for example directly during the electronic storage of the knowledge data. The quality of the knowledge data can thus be determined from the corresponding quality measure in relation to expectation values defined in advance for the quality measure, e.g. according to a predefined metric.

Thus, the result stored in the result database may then also be converted automatically into a quality measure. For example, if knowledge data leads to a patient recovery within 2 weeks, which was previously estimated at 4 weeks on average by acknowledged experts, then the quality measure is a factor of 2 when the quality criterion is the factorial reduction of the recovery time. If the quality criterion is based on a predefined metric, then a comparable objective numerical value is thus determined as the quality measure.

If quality data can only be determined from the result database according to the preselected quality criteria with a time delay, then an access path to the result database may be assigned to the quality criterion.

The identification of the user may simply be stored as an access path, so that the evaluation can be requested with it and is not lost or forgotten. Each evaluation entering the database as quality data is thus assigned to the correct knowledge data. The access path may moreover be a webpage link sent to the user, on which they can then enter their results achieved from the knowledge and from where these are assigned to the associated knowledge data.

A result database denoted by the access path may be automatically checked at predetermined times for the presence of the result data assigned to the quality criteria. When the result data are present, quality data are generated from them according to the quality criteria and stored in the database.

Neither the user nor the operator of the database needs to deal with the quality evaluation. Depending on the time interval between two requests, the quality data are available as soon as desired after entry of the results into the result database.

The entries into the result database may in this case be flexibly configured, i.e. any information in the result database can be assessed, irrespective of whether it is for example in the form of free text or objectively verifiable measurement values.

If a quality measure is determined as quality data, then a determination instruction for the quality measure may be stored in the database.

A quality measure has quantitative character and may, for example, be a percentage specification such as “reduction of the working time compared to the standard method: 50%” or a qualitative expression such as “very reliable” or “rarely leads to success”, “the information was very helpful to me”. It may nevertheless involve the number of previous read accesses to the knowledge data, date or frequency of the last use etc.

If a description of the determination of the quality measure is stored in the quality data then, after allocating a quality measure and assigning it to the knowledge data, not only the determined quality measure but also its source, mode of determination etc. are available during further use of the knowledge data, which provides the user with further quality information. By comparing various evaluation procedures of different knowledge data, for example, they can moreover relate of these to one another even though the respective quality measures are not directly comparable.

The determination instruction may be a formula or an expert rule. In this case, the quality measure is accessible at any time as a result of the determination instruction and comparable with other quality measures which have been determined or are to be determined.

A quality evaluation of the knowledge data, for example by a quality measure, may be used for ranking, benchmarking or quality determination. Benchmarking, for example, in this case leads to a ranking order of institutions, processes or applications graded according to reliability or success rate. In hospitals which are comparable i.e. with the same size, specialist orientation etc., for example, the same therapies are carried out based on particular knowledge data. The number of successful therapies as a percentage of the total number of therapies carried out is used as a quality measure. A corresponding quality measure can thus be assigned to each of the hospitals, which leads to a classification of the hospitals relating to the success of the therapy in the respective hospital. Since the therapies based on the same underlying knowledge data do not differ, the quality measure is a criterion for the quality of the hospital, for example its staff, the technical equipment, the therapy compliance etc.

When different users use the same knowledge data and quality data assigned to the users are determined therefrom, then a ranking of the success rate of the users can be calculated from the quality data.

The quality of the knowledge data for different uses is therefore comparable. The ranking may be displayed or stored in a database.

Depending on the quality criteria, the quality measure thus allows inferences not only about the quality of the knowledge data but also about that of the users.

Instead of the users or uses, the knowledge data themselves may also be put into a relative quality sequence. To this end, comparable knowledge data are used and quality data assigned to the knowledge data are determined therefrom. A ranking of the quality of the knowledge data is then calculated from the quality data.

Knowledge data may be released for use by the user only after the user has assigned their identification to the knowledge data or an access path for result data from the use of the knowledge data.

An address, especially an e-mail address, or any other indication of how the user can be reached, may be used as an identification.

The knowledge data are thus released only subject to conditions, for example that a subjective evaluation must be carried out by the user at the end of the reading.

Especially when a use of the knowledge data must necessarily lead to a quality evaluation, no use must take place from which a report is not received. Content must therefore be added to the quality data each time the knowledge data are used.

The knowledge data may be released for use by the user only after the user has paid a fee. The user receives a reimbursement of the fee after storing the quality data.

The user may, for example, pay the fee by debit from a credit card account. Reimbursement may then be envisaged in the form of cash or other monetary benefits. For example, the reimbursement is not given until they enter the quality evaluation data about the knowledge data, which are demanded after use of the knowledge data, into a database.

The quality measures determined by the method can thus be incorporated into the business model which relates to the purchase or sale of information and knowledge. For example, quality-dependent remuneration models can be produced for the provision of knowledge. The evaluation and creation of the knowledge data are accessible. Through the quality measure correlated with the knowledge data in the quality data, the user has the opportunity to judge for themselves how trustworthy they find the offered knowledge data. Topicality, frequency of use, number of hits with subsequent nonuse etc. are thus available for example to a buyer of information.

If the use of the knowledge data is chargeable to the user, then the quality data, but not the assigned knowledge data, can be seen freely by the user.

On the basis of the quality data, for instance, the user may decide in advance for or against chargeable use of the knowledge data.

Quality assurance data may relate not only to the knowledge data, but again to the quality data. The date of the creation of the quality data may be stored in the database together with the quality data. Thus, not only the knowledge itself but also the evaluation of the knowledge is provided with a date stamp, and the topicality of the quality expressions can be checked at any time.

Medical treatment recommendations or advice may be stored as knowledge data. For example, a knowledge database is suitable as a health platform for anyone to seek medical advice.

Medical guidelines may be stored as knowledge data. In this way, it is rather the treatment methods to be found in clinical routine which are evaluated according to quality, reliability, empirical values etc. A database set up with medical guidelines may, for example, help doctors and other medical personnel to find the respectively most efficient treatment method in clinical routine.

### BRIEF DESCRIPTION OF THE DRAWINGS

For a further description of the invention, reference will be made to the example embodiments of the drawings in which, in a schematic outline sketch:

FIG. 1 shows a flow chart for the quality evaluation of the description of a cancer therapy.

### DETAILED DESCRIPTION OF THE EXAMPLE EMBODIMENTS

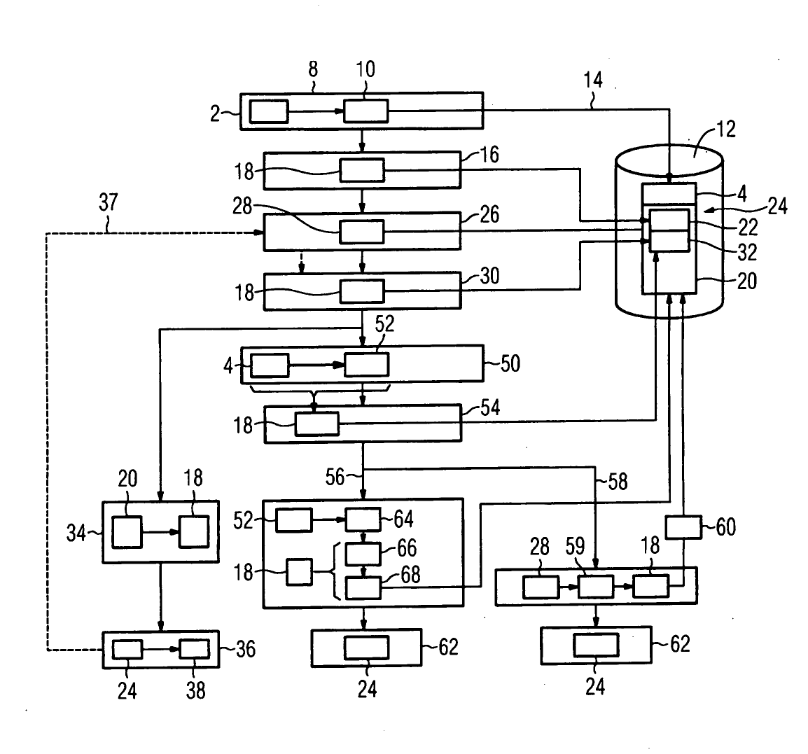

In the example on which FIG. 1 is based, a research institution 2 has developed a new method for cancer therapy and has compiled an accurate description 4 of it. The new method is supposed to reduce the therapy time until a cancer lesion vanishes from previously 12 to 8 months.

In a starting step 8 of the quality evaluation method represented in FIG. 1, as indicated by the arrow 14, the research institution 2 sends the description 4 and all relevant information, working procedures etc. of the method to an Internet service provider 10, which stores the description 4 in a data memory 12 connected to the Internet.

In a first quality assurance step 16, a quality management system 18 present at the Internet service provider 10 adds quality data 20 to the description 4 stored in the data memory 12. An abstract 22 is stored in the quality data. It contains the originator of the knowledge, i.e. the address etc. of the research institution 2, date, person and description data of the development of the method and the persons, contacts involved in it. Access data 32, which contain information about the write and read access to the description 4, are furthermore added to the quality data. The quality data 20 correlated with the description 4 thus represent meta-information for the description 4.

The quality data 20 and the associated description 4 are inseparably connected together, for example by a capsule technology. This creates a knowledge capsule 24 which, besides the actual knowledge i.e. the description 4, contains the quality data 20 associated with the knowledge. Each access to the knowledge data in the form of the description 4, i.e. reading, writing, forward communication, evaluation, requires “opening” of the capsule, which can in turn be documented, tracked or protected by password access or the like.

In a reading step 26, a doctor 28 planning a cancer therapy on a patient 52 learns about the new cancer therapy method through the description 4 by reading the knowledge capsule 24 out from the data memory 12. Since the description 24 can only be opened i.e. read out inside and together with the entire capsule 24, the doctor also automatically obtains all the meta-data about the description 4 so far available in the quality data 20.

The abstract 22 tells the doctor 28 that the description 4 was developed by the research institution 2, with which they have had extremely good experience in the past. They know the scientists involved in the development personally and trust them. From the access data 32, they find that the description 4 has never yet been read, i.e. there is not yet any further experience about it. The doctor 28 decides to carry out the method according to the description 4 on their patient 52.

The reading step 26 entails a registration step 30 in the quality management system 18, which logs the read access by the doctor 28 to the knowledge capsule 24 in the access data 32. The fact that the user of the description 4 is the doctor 28 is stored there. The date and time of the read access are logged in the access data 32.

In an updating step 34 carried out by the quality management system 18, an assessment of the access data 32 is carried out since they have changed. This leads to a modified representation 36 of the knowledge capsule 24. If it is requested by another user 38 in a new reading step 26, as indicated by the arrow 37, then the user 38 is informed in the modified representation of the knowledge capsule 24 that the doctor 28 queried the knowledge 4 at the documented time but there has not yet been any report about the use of the knowledge.

The user 38 finds that the description 4 is not interesting to them. In the new registration step 30 following the reading step 26, the access by the user 38 to the knowledge capsule 24 is added to the access data 32 by the quality management system 18. The user 38 decides not to use the description 4 and informs the quality management system 18 of this, whereupon the latter compiles a corresponding entry in the quality data 20. The process connected with the user 38 is therefore concluded and ends here.

In the meantime, the doctor 28 carries out the cancer therapy described in the description 4 on their patient 52 in a treatment step 28. This is in turn registered in the registration step 54 by the quality management system 18 and logged in the quality data 20.

Two alternative method variants, indicated by the paths 56 and 58, are possible at this point in the example method according to FIG. 1.

According to path 58, based on their subjective and therefore freely specified quality criteria 59, the doctor 28 evaluates how useful the knowledge in the form of the description 4 is or was for them with respect to the treatment of the patient 52. For this purpose, they describe and evaluate the disease profile of their patient 52 and the therapy carried out in the form of free text, which the quality management system 18 stores as a quality measure in a quality description 60 and adds to the quality data 20. To this end, the free text data are provided with context information, such as time of entry, address of the doctor 28 etc.

The representation 62 of the knowledge capsule 24 thereupon changes so that a user, who later reads the description 4 out from the data memory 12, is also provided with the quality description 60 and thus obtains additional information about the new cancer therapy.

In contrast to the path 58, an automatic quality evaluation of the application of the description 4 by the doctor 28 takes place in the alternative path 56. To this end, the quality management system 18 reads out an electronic patient file 64 of the patient 52 and extracts the recovery time of the patient 52 therefrom. The length of the recovery of the patient 52, determined from the admission and discharge dates of the patient in the clinic of the doctor 28, is used as a quality criterion. From a comparison of the actual recovery time with the average recovery time of previous patients who were treated with conventional methods, i.e. 12 months, and the recovery time measured at 9 months for the patient 52, a numerical quality measure 68 is calculated and added to the quality data 22.

In the example, for example, this was a reduction by 3 months compared to the 4 months claimed by the research institution 2, which corresponded to a quality measure 68 of 75%. The quality measure 68 is in turn added to the quality data 20. The description for determining the quality measure 68 (calculation instruction, underlying data, boundary conditions, etc.) is stored together with this value in the quality data 20.

The representation 62 of a future read access to the knowledge capsule 24 in turn changes accordingly, as described above, so that a new user of the description 4 receives the knowledge capsule 24 together with the quality measure 68.

A direct or subsequent observation of the treatments, consequences, uses, damage etc., resulting from the description 4, which cannot be lost, enters into the quality evaluation of the description 4 and characterizes it, thus takes place in both alternative paths.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for the quality evaluation of electronically stored, knowledge data the method comprising:
storing knowledge data in a database; and
correlating quality data with the knowledge data stored in the database, a user at least one of storing the quality data in the database at least one of during and after access to the knowledge data, and storing result data from the application of knowledge data in a result database and correlating quality data with the result data, the application of the knowledge data being automatically generated and stored in the database and, upon the user accessing the knowledge data, the quality data automatically being provided to the user.

2. The method as claimed in claim 1, wherein
the user applies the knowledge data, and
quality data correlated with the results of the application are stored in the database.

3. The method as claimed in claim 1, wherein
quality criteria correlated with the knowledge data are stored in the database.

4. The method as claimed in claim 1, wherein
an identification of the user is assigned to the quality data and stored in the database.

5. The method as claimed in claim 1, wherein
the user determines quality data with a time delay after application of the knowledge data, and
the user is automatically requested to store the quality data in the database.

6. The method as claimed in claim 1, wherein
the result database is at least one of an electronic patient database and an electronic hospital information system, and
patient outcome data are stored as result data in the result database.

7. The method as claimed in claim 1, wherein
quality data are determined from the result database according to quality criteria, and
the quality data are stored in the database.

8. The method as claimed in claim 1, wherein
quality data are determined from the result database according to the quality criteria with a time delay, and
an access path to the result database is assigned to the quality criterion.

9. The method as claimed in claim 8, wherein
a result database denoted by the access path is automatically checked for the presence of the result data assigned to the quality criteria, and
when the result data are present, quality data are generated from them according to the quality criteria and stored in the database.

10. The method as claimed in claim 1, wherein
a quality measure is determined as quality data, and
a determination instruction for the quality measure is stored in the database.

11. The method as claimed in claim 10, wherein
the determination instruction is at least one of a formula and an expert rule.

12. The method as claimed in claim 1, wherein
different users use the same knowledge data and quality data assigned to the users are determined therefrom, and
a ranking of the success rate of the users is calculated from the quality data.

13. The method as claimed in claim 1, wherein
comparable knowledge data are used and quality data assigned to the knowledge data are determined therefrom, and
a ranking of the quality of the knowledge data is calculated from the quality data.

14. The method as claimed in claim 1, wherein
knowledge data are released for use by the user only after the user has assigned their identification to the knowledge data or an access path for result data from the use of the knowledge data.

15. The method as claimed in claim 1, wherein
knowledge data are released for use by the user only after the user has paid a fee, and
the user receives a reimbursement of the fee after storing the quality data.

16. The method as claimed in claim 1, wherein
the use of the knowledge data is chargeable to the user, and
the quality data, but not the assigned knowledge data, is freely viewable by the user.

17. The method as claimed in claim 1, wherein
the date of the creation of the quality data is stored in the database together with the quality data.

18. The method as claimed in claim 1, wherein
at least one of medical treatment recommendations advice is stored as knowledge data.

19. The method as claimed in claim 1, wherein
medical guidelines are stored as knowledge data.

20.-21. (canceled)

22. The method as claimed in claim 2, wherein
quality criteria correlated with the knowledge data are stored in the database.

23. The method as claimed in claim 6, wherein
quality data are determined from the result database according to quality criteria, and
the quality data are stored in the database.

24. The method as claimed in claim 6, wherein
quality data are determined from the result database according to the quality criteria with a time delay, and
an access path to the result database is assigned to the quality criterion.

25. The method as claimed in claim 7, wherein
quality data are determined from the result database according to the quality criteria with a time delay, and
an access path to the result database is assigned to the quality criterion.

26. The method as claimed in claim 23, wherein
quality data are determined from the result database according to the quality criteria with a time delay, and
an access path to the result database is assigned to the quality criterion.

27. The method as claimed in claim 26, wherein
a result database denoted by the access path is automatically checked for the presence of the result data assigned to the quality criteria, and
when the result data are present, quality data are generated from them according to the quality criteria and stored in the database.

28. The method as claimed in claim 1, wherein the knowledge data is medical knowledge data.

29. A method for quality evaluation of electronically stored knowledge data the method comprising:
storing knowledge data in a database;
correlating quality data with the knowledge data stored in the database; and
automatically providing, upon the user accessing the knowledge data, the quality data to the user.

30. The method as claimed in claim 29, wherein the knowledge data is medical knowledge data.
